(19) United States
(12) Patent Application Publication
(10) Pub. No.: US 2020/0030811 A1
(43) Pub. Date: Jan. 30, 2020

(54) MOBILE WOOD CHIPPING SYSTEM

(71) Applicant: NICK ARDEN, ROUND ROCK, TX (US)

(72) Inventor: NICK ARDEN, ROUND ROCK, TX (US)

(21) Appl. No.: 16/517,113

(22) Filed: Jul. 19, 2019

Related U.S. Application Data
(60) Provisional application No. 62/703,998, filed on Jul. 27, 2018.

(51) Int. Cl. B02C 21/02; B27L 11/00; A01G 3/00; B27L 11/02

(52) U.S. Cl. CPC B02C 21/02; B27L 11/005; B27L 11/02; A01G 3/002; B27L 11/002

(57) ABSTRACT

A mobile wood chipping system is disclosed. The mobile wood chipping system includes a trailer frame, a wood chipper and a dump box. The trailer frame includes at least one axle on which a set of wheels are mounted. The wood chipper, which is securely mounted on the trailer frame, includes a feeder horn and a discharge pipe. The dump box, which is pivotally mounted on the trailer frame, includes an open top and a door. The dump box can be moved between a horizontal position and a tilted position by a hydraulic piston attached to the trailer frame and dump box.

### PRIORITY CLAIM

The present application claims priority under 35 U.S.C. § 119(e)(1) to provisional application No. 62/703,998 filed on Jul. 27, 2018, the contents of which are incorporated herein by reference.

### TECHNICAL FIELD

The present invention relates to wood chippers in general, and in particular to a mobile wood chipping system.

### BACKGROUND

When comes to tree trimming or pruning, it is a common practice to bring a wood chipper to a job site. By using a wood chipper, a worker can reduce bulky tree branches and debris to small wood chips. The small wood chips can be tightly packed in a storage container, which reduces storage and transportation costs.

The present disclosure provides an improved wood chipping system.

### SUMMARY

In accordance with a preferred embodiment of the present invention, a mobile wood chipping system includes a trailer frame, a wood chipper and a dump box. The trailer frame includes at least one axle on which a set of wheels are mounted. The wood chipper, which is securely mounted on the trailer frame, includes a feeder horn and a discharge pipe. The dump box, which is pivotally mounted on the trailer frame, includes an open top and a door. The dump box can be moved between a horizontal position and a tilted position by a hydraulic piston attached to the trailer frame and dump box.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 illustrates a side view of a mobile wood chipping system, according to one embodiment;

FIG. 2 illustrates a side view of the mobile wood chipping system from FIG. 1 when a dump box is in a tilted position, according to one embodiment;

FIG. 3 shows a deflector, according to one embodiment;

FIG. 4 illustrates a front view of a door of the mobile wood chipping system from FIG. 1, according to one embodiment; and

FIG. 5 shows a discharge pipe in a collapsed position, according to one embodiment.

### DETAILED DESCRIPTION OF A PREFERRED EMBODIMENT

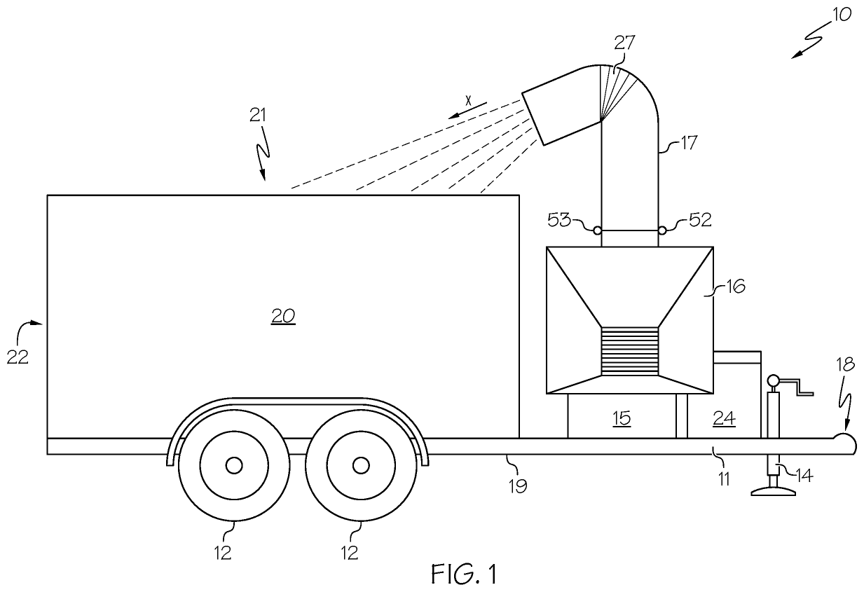

Referring now to the drawings and in particular to FIG. 1, there is illustrated a side view of a mobile wood chipping system, according to one embodiment. As shown, a wood chipping system 10 includes a trailer 11, a wood chipper 15, and a dump box 20. Trailer 11 includes a frame 19 having a hitch 18 that can be connected to a truck (not shown) when trailer 11 is in tow. Frame 19 includes one or more axles to which wheels can be attached. For the present embodiment, frame 19 includes two axles to which four wheels 12 are attached. Frame 19 can be equipped with hydraulic or electric brakes (not shown). Frame 19 also includes a jack stand 14 having a manual hydraulic jack for maintaining the levelness and stability of frame 19 when trailer 11 is stationary.

Wood chipper 15, which is securely attached to frame 19, includes a feeder horn (hopper) 16 and a discharge pipe 17. Specifically, wood chipper 15 is mounted at the aft end (near hitch 18) of dump box 20. Tree branches and leaves can be hand-fed into wood chipper 15 by a user through feeder horn 16. A motor 24 turns a set of blades within wood chipper 15 to cut the tree branches and leaves into small wood chips. After the tree branches and leaves have been reduced to small wood chips by the blades within wood chipper 15, the small wood chips can come out of wood chipper 15 via discharge pipe 17 in the x direction towards dump box 20.

Dump box 20, which is pivotally attached to frame 19 at the opposition end of hitch 18, includes an open top 21 and a door 22 located at one end of dump box 20. The height of dump box 20 is approximately 4 feet, the length of dump box 20 is approximately 10 feet, and the width of dump box 20 is approximately 5 feet.

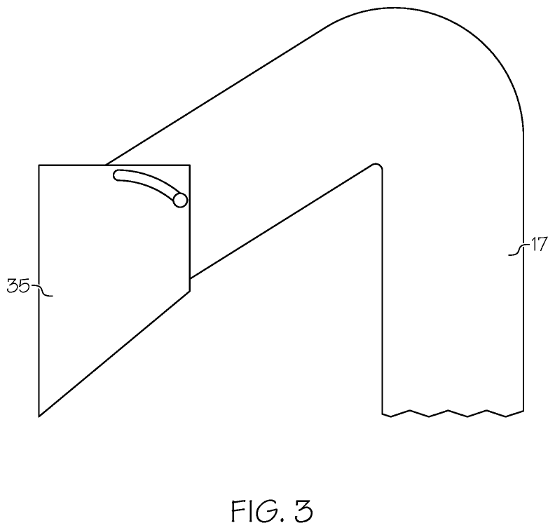

When dump box 20 is in a horizontal position, as shown in FIG. 1, door 22 is closed in order to prevent small wood chips from coming out dump box 20. The direction where small wood chips coming out of the opening of discharge pipe 17 can be periodically adjusted via flexible joints 27. Alternatively, an adjustable deflector 35, as shown in FIG. 3, can be mounted near the opening of discharge pipe 17 for re-directing the direction where small wood chips coming out of the opening of discharge pipe 17. As such, it is not necessary for a user to manually shuffle the small wood chips inside dump box 20 to insure consistency in the level of the small wood chips within dump box 20 in order to maintain proper balance of the load. Dump box 20 can also be utilized to store the small wood chips coming out of discharge pipe 17.

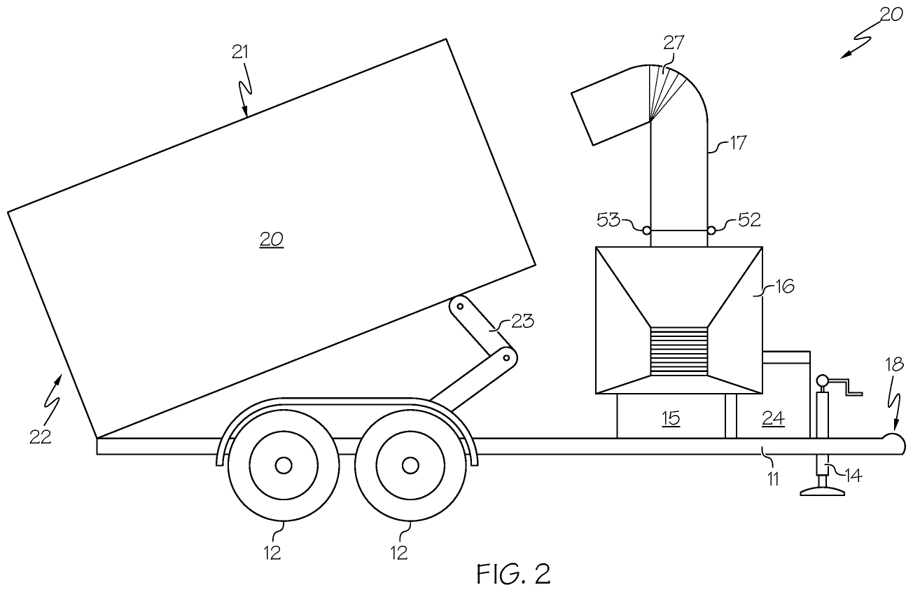

With reference now to FIG. 2, there is depicted a side view of mobile wood chipping system 10 when dump box 20 is in a tilted (or inclined) position, according to one embodiment. As shown, dump box 20 is being tilted to an inclined position by a hydraulic piston (cylinders) 23 connected between dump box 20 and trailer frame 19. Motor 24 is selectively connected to wood chipper 15 and hydraulic piston 23. Before lifting dump box 20, the blades within wood chipper 15 are disengaged from motor 24 such that blades are not being rotated by motor 24 to cut tree branches. Motor 24 is then coupled to hydraulic piston 23 in order to provide power to hydraulic piston 23 for lifting dump box 20 at one end. Alternatively, a separate small motor (not shown) can be utilized to provide power to hydraulic piston 23 for lifting dump box 20. After dump box 20 has been tilted to a predetermined position, door 22 can be opened to allow small wood chips coming out of dump box 20 for disposal or recycle.

After the contents in dump box 20 have been emptied, dump box 20 can be placed back in a horizontal position by slowly releasing the pressure within hydraulic piston 23. At this point, motor 24 can be decoupled from hydraulic piston 23, and is then re-engaged with the blades within wood chipper 15 for the purpose of cutting tree branches.

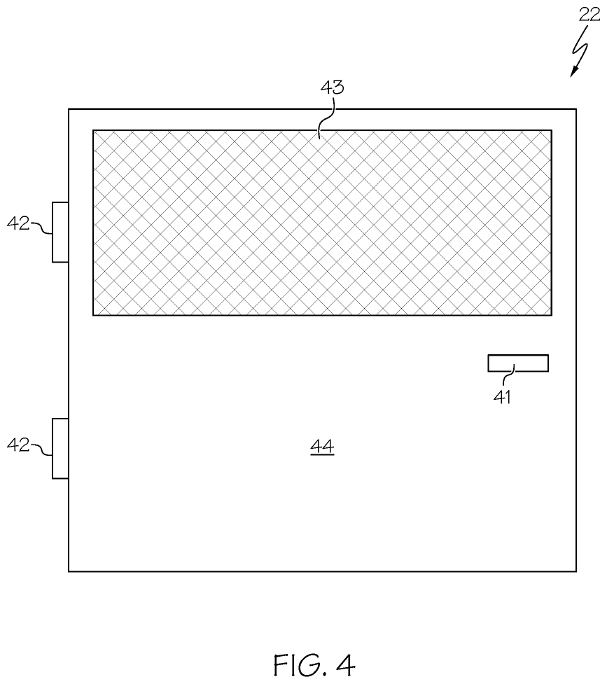

With reference now to FIG. 4, there is illustrated a front view of door 22, according to one embodiment. As shown, door 22 includes a handle and lock 41 and hinges 42. Hinges 42 are shown to be on the lefthand side, but it is understood by those skilled in the art that hinges 42 can also be installed at the righthand side. Door 22 includes a solid section 44 located underneath a mesh section 43. The ratio between the height of mesh section 43 and the height of solid section 44 can be from 1:20 to 1:1. Mesh section 43 allows a user to observe the inside of dump box 20 before opening door 22. For example, it allows a user to realize that there are small wood chips inside dump box 20 before opening door 22.

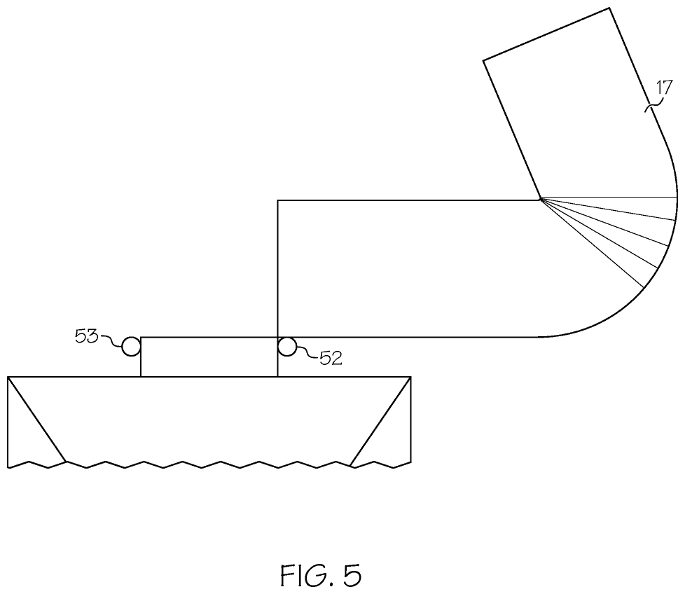

Referring now to FIG. 5, there is shown discharge pipe 17 in a collapsed position, according to one embodiment. During transportation of wood chipping system 10, discharge pipe 17 can be placed in a collapsed position by releasing a connector 53. The purpose of placing discharge pipe 17 in the collapsed position is to allow wood chipping system 10 to have a lower height profile during transportation as well as during storage in a storage facility. During operation, discharge pipe 17 is placed in an upright position via connector 53 and a hinge 52, as shown in FIGS. 1-2.

As has been described, the present invention provides an improved mobile wood chipping system.

While the invention has been particularly shown and described with reference to a preferred embodiment, it will be understood by those skilled in the art that various changes in form and detail may be made therein without departing from the spirit and scope of the invention.

What is claimed is:

1. A mobile wood chipping system comprising:
a trailer frame having an axle;
a plurality of wheels mounted to said axle;
a wood chipper securely mounted on said trailer frame, wherein said wood chipper includes
a feeder horn for receiving tree branches; and
a discharge pipe for discharging wood chips; and
a dump box pivotally mounted on said trailer frame, wherein said dump box includes an open top through which said discharged wood chips enter said dump box, and a door through which said discharged wood chips exit said dump box; and
a hydraulic piston attached to said trailer frame and said dump box, wherein said hydraulic piston moves said dump box between a horizontal position and a tilted position.

2. The mobile wood chipping system of claim 1, wherein said discharge pipe include at least one flexible joint to allow the direction of an opening of said discharge pipe to be changed.

3. The mobile wood chipping system of claim 1, wherein said door includes a mesh section and a solid section.

4. The mobile wood chipping system of claim 1, wherein said door is now allowed to be opened after said dump box is in a horizontal position.

5. The mobile wood chipping system of claim 4, wherein said door is allowed to be opened after said dump box has been tilted to a predetermined position to let small wood chips coming out of said dump box.

6. The mobile wood chipping system of claim 1, wherein a motor is selectively connected to said wood chipper and said hydraulic piston.

7. The mobile wood chipping system of claim 1, wherein a first motor is connected to said wood chipper and a second motor is connected to said hydraulic piston.
